(19) United States
(12) Patent Application Publication
(10) Pub. No.: US 2026/0184228 A1
(43) Pub. Date: Jul. 2, 2026

(54) Motor Vehicle Component, Motor Vehicle With a Motor Vehicle Component, Assembly With a Motor Vehicle and Method for Exchanging a Motor Vehicle Component

(71) Applicant: Bayerische Motoren Werke Aktiengesellschaft, Muenchen (DE)

(72) Inventor: Erwin WEIGL, Emmering (DE)

(21) Appl. No.: 19/131,352

(22) PCT Filed: Nov. 20, 2023
(86) PCT No.: PCT/EP2023/082327

§ 371 Date: May 20, 2025

(30) Foreign Application Priority Data
Nov. 21, 2022 (DE) 10 2022 130 659.3

(51) Int. Cl. B60L 53/80

(52) U.S. Cl. CPC B60L 53/80

(57) ABSTRACT

The present disclosure relates to a motor vehicle structural unit comprising an electric storage device and a charging module for charging the electric storage device. The electric storage device and the charging module are secured to each other and form an inherently rigid self-supporting structural unit, wherein the motor vehicle structural unit can be replaced. The present disclosure also relates to a motor vehicle comprising a motor vehicle structural unit and to an assembly comprising a motor vehicle. The present disclosure additionally relates to a method for replacing a motor vehicle structural unit.

### BACKGROUND AND SUMMARY

The present disclosure relates to a motor vehicle assembly and also to a motor vehicle with a motor vehicle assembly. The present disclosure also relates to an assembly with a motor vehicle and a method for exchanging a motor vehicle assembly.

In the following, the term “motor vehicle” is utilized to be synonymous with the term “electrically powered motor vehicle”. This also includes “at least partially electrically powered motor vehicles”.

The drive unit of an electrically powered vehicle is usually provided by an electrical storage unit, which is installed in the vehicle.

This electrical storage unit is typically designed individually for each vehicle model, or with a minimum requirement for each vehicle platform, in order to make the best possible use of the space available for the electrical storage unit in the vehicle, and subsequently integrated into the vehicle in such a way that the electrical storage unit cannot be easily removed from the vehicle due to adhesion which is provided and that prevent the ingress of water and due to a large number of screw connections, some of which are difficult to access. It is therefore deemed to be practically “permanently” installed in the vehicle. This is generally referred to as high integration of the electrical storage system in the vehicle.

These electrical storage units must always be recharged at regular intervals at an appropriate charging device. The charging device thereby feeds electrical energy into the vehicle and the former is thereby utilized to recharge the electrical storage system it contains.

Vehicles can be fitted with different electric storage variants. For used vehicles in particular, vehicles with a specific electric storage system are only therefore suitable for a specific customer group.

Furthermore, electrical energy storage systems are subjected to indications of ageing. For example, the electrical storage system itself could have reached the end of its life cycle, while the rest of the vehicle, such as the bodywork, the electric drive unit and the chassis, is still considered to satisfy the roadworthiness requirements. This can depend in particular on the respective areas of application or the charging processes which are involved. Furthermore, technological advances are constantly being implemented in the field of electrically powered vehicles. It would therefore also be conceivable to replace technically obsolete batteries with more modern batteries. A “permanently installed” electrical storage system is disadvantageous because of the costs involved for replacement and the material costs themselves are extremely high.

As an alternative to the “permanently installed” electrical storage units which have been described above, interchangeable electrical storage units are also known in the prior style. With these, the electrical storage unit can be exchanged automatically at an exchange station, for example, in order to exchange an electrical storage unit with a low charging status for the same electrical storage unit with a high charging status. However, the construction of such exchange stations is extremely expensive, complex and always requires a lot of space. For this reason, it is not possible to provide these stations as a standardized solution.

In principle, and in addition to the “permanently installed” electrical storage units, interchangeable electrical storage units of motor vehicles must also therefore be suitable for being recharged at regular intervals at other corresponding charging devices, such as charging stations.

The charging device can be a DC voltage source or an AC voltage source. Whether a vehicle can be charged by DC or AC voltage always depends on the charging technology of the charging module installed in the vehicle. If a converter is present, then the vehicle is suitable for charging from an AC voltage source, whereby the AC voltage is subsequently converted into a DC voltage by the charging unit and this DC voltage is subsequently utilized to supply the electrical storage unit with electrical energy. If a voltage transformer is present, then the vehicle is suitable for charging from a DC voltage source, whereby the voltage transformer only executes a voltage transformation, and the electrical storage unit is supplied with electrical energy by the transformed voltage. If the vehicle is also intended for bidirectional charging i.e. feeding back electrical energy into it, then an inverter is also provided, by which electrical energy is fed from the electrical storage unit into a power grid.

The power with which electrical storage systems can be charged depends on the charging device itself, and the electrical storage system, but also on the charging module which has been installed in the vehicle and its dimensions.

Charging modules in the form of voltage converters, rectifiers and/or inverters are installed “deep” within the vehicle and are typically difficult to access and can only be replaced with great effort.

This also has a detrimental effect when the charging module, which has been installed in the vehicle, is defective and has the disadvantage that vehicles which are already available on the market, and which have been equipped with special charging technology that does not gain popularity when the charging infrastructure is expanded, lose a great deal of their value and suitability for everyday use.

Based on this, a task of the present disclosure is to provide an electrical storage unit and also a charging module which can enable flexible adaptation so that the vehicle value is decoupled from these components and these components can subsequently be replaced at an economically justifiable cost.

In accordance with one or more aspects of the present disclosure, this problem is solved by a motor vehicle structural unit with an electrical storage unit and a charging module for charging the electrical storage unit. The electrical storage unit and the charging module are attached together and thereby form an inherently rigid, self-supporting structural unit. The motor vehicle unit is deemed to be interchangeable.

According to one or more aspects of the present disclosure, the electrical storage unit is combined with the charging module in a motor vehicle unit to integrate these components into the motor vehicle in a replaceable manner. This makes it possible to exchange the vehicle unit as a whole and to jointly replace the electrical storage unit and the charging module at any time. The vehicle unit can be selected in such a way that it contains a charging module which has been adapted to the available charging infrastructure. In other words, variable equipment with suitable charging solutions can be realized over the entire service life of the vehicle.

This is due to the fact that not only the electrical storage unit is interchangeable, but also the entire vehicle assembly, which thereby includes both the electrical storage unit and the charging module.

According to one aspect of the present disclosure, the charging module can comprise a converter which is designed to charge the electrical storage device via an alternating current source. Furthermore, the charging module can comprise a voltage converter which has been designed to charge the electrical storage device via a DC voltage source. Consequently, the charging module and its components can be adapted to the available charging infrastructure in order to increase the vehicle's suitability for everyday use and ensure optimum charging times.

An inverter can also be provided so that the vehicle is designed for bidirectional charging. The inverter can also be a component of the charging module.

Alternatively, or additionally, the charging module can be equipped with an inductive charging system and/or a conductive charging system. The inductive charging system can increase convenience for the user, because conductive connection does not need to be established. For a conductive charging system, on the other hand, it can therefore always be ensured that there are no metallic objects located between the components of an inductive charging system.

This also enables the vehicle unit to be adapted to the existing charging infrastructure. It therefore permits the user to select a vehicle unit which is equipped with a charging system that fulfills their individual requirements.

The present disclosure also relates to a motor vehicle with a motor vehicle assembly unit, whereby the assembly unit is integrated in the motor vehicle in such a way that the motor vehicle assembly unit is exposed downwards on the underbody of the vehicle. The replaceable motor vehicle assembly unit is accessible from the vehicle underbody and can be easily replaced. In addition, a detachable fastening device, which is freely and directly accessible from below, can be provided for central coupling and decoupling of the replaceable assembly unit from the vehicle body.

This fastening device therefore ensures that the interchangeable unit can be simply and quickly decoupled from the vehicle body but can also be quickly and securely coupled to it.

The fastening device, which is freely and directly accessible from below, is particularly suitable for automatically coupling or decoupling the unit centrally with the vehicle body.

Furthermore, an initial vehicle-side interface can be provided on the motor vehicle, to which the charging module can be automatically coupled during connection and disconnection, whereby the initial interface electrically couples a charging socket, which has been provided on the motor vehicle, to the charging module. The automatic coupling simplifies the installation and removal of the motor vehicle unit and therefore enables electrical energy to be fed into the electrical storage system via the charging socket and the charging module when the motor vehicle unit is installed.

Furthermore, a second vehicle-side interface can be provided on the motor vehicle, to which the electrical storage unit can be automatically coupled when connecting and disconnecting, whereby the second interface directly or indirectly couples or decouples an electrical drive unit electrically, which has been provided on the motor vehicle with the electrical storage unit. This also makes it easier to exchange the motor vehicle unit and ensures that electrical energy can be interchanged between the electric drive unit and the electric storage unit.

Furthermore, the motor vehicle assembly can at least partially create the underside i.e. the chassis component of the motor vehicle. It is therefore ensured that the underside of the motor vehicle assembly facing the ground is freely accessible. In this respect, the underside of the motor vehicle assembly, together with the floor of the vehicle body, thereby creates the vehicle underbody.

In addition, a second motor vehicle structural unit with an electrical storage unit and a charging module is provided outside the motor vehicle. The electrical storage unit and the charging module of the second motor vehicle assembly are attached together and thereby create an inherently rigid, self-supporting structural unit. The electrical storage unit and/or the charging module of the second motor vehicle structural unit, which has been provided outside the motor vehicle, hereby differs from the motor vehicle structural unit provided in the motor vehicle in that it is created with different dimensions and/or technology.

Consequently, the second motor vehicle unit is not the same as the motor vehicle unit which has been installed in the vehicle, so that it could, for example, be larger in order to achieve longer driving ranges, or the electric storage unit possesses a specific storage technology which has advantages over the previous electric storage unit which has been installed. Furthermore, the charging module could also be suitable for charging the electric storage unit more quickly or could also include corresponding technology which is advantageous with regard to the available charging infrastructure.

The equipment therefore remains variable with regard to the vehicle unit throughout the entire service life of the vehicle.

Please refer to the aforementioned explanations with regard to the additional benefits.

Furthermore, the second motor vehicle unit can also be equipped with an interface for exchanging thermal energy between the motor vehicle and an infrastructure.

It is therefore possible to provide the vehicle with additional interfaces throughout its entire service life. In this way, the vehicle can be heated with low outside temperatures or its waste heat can be utilized after operation in order to heat the infrastructure which is connected via the interface.

In addition, the task mentioned at the beginning is hereby solved by a method for exchanging a motor vehicle assembly unit, with the following steps:
a) Automated release of a detachable fastening device which is freely and directly accessible from below and decoupling of an replaceable motor vehicle structural unit from a vehicle body by a mounting device,
b) Decoupling of a charging module of the structural unit from an initial vehicle-side interface and/or decoupling of an electrical storage device of the motor vehicle structural unit from a second vehicle-side interface,
c) Provision of a second motor vehicle assembly unit provided outside the motor vehicle, the electrical storage and/or charging module of which differs from the motor vehicle assembly unit which has been originally provided in the motor vehicle in terms of a different dimensioning and/or technology,
d) Automated locking of the fastening device, which is freely and directly accessible from below and coupling of the second replaceable motor vehicle structural unit to the vehicle body by the mounting device and
e) Coupling of a charging module of the second motor vehicle structural unit into the first vehicle-side interface and/or coupling of an electrical storage device of the second motor vehicle structural unit into the second vehicle-side interface.

As a result, the vehicle assembly can be replaced automatically, quickly and easily, so that a vehicle can be subsequently fitted with a new or technologically improved vehicle assembly or one which has been adapted to the user's requirements within a very short time.

In principle, aspects of the present disclosure therefore ensure that the motor vehicle is variably equipped throughout its service life with regard to the charging solutions, which is achieved by the fact that the electrical storage unit and the charging module have been integrated together in the motor vehicle unit. The charging module can include the required hardware and, if necessary, the required interfaces, which can therefore be jointly exchanged with the electrical storage unit. In other words, the required hardware and, if applicable, the necessary interfaces have been arranged, in particular moved outwards, in such a way that they can be jointly exchanged with the exchangeable electrical storage unit, namely via the motor vehicle assembly unit, which contains the electrical storage unit and the charging module.

Aspects of the present disclosure are described below with reference to one or more embodiments, which is shown in the accompanying drawings.

### BRIEF DESCRIPTION OF THE DRAWINGS

FIG. 1 is a schematic representation of a motor vehicle with a motor vehicle assembly according to one or more embodiments.

FIG. 2 is a schematic representation of an assembly with the motor vehicle from FIG. 1 and a second motor vehicle unit provided outside the motor vehicle.

FIG. 3 illustrates the assembly from FIG. 2 with a schematic mounting device.

FIG. 4 illustrates the assembly from FIG. 2, with the second motor vehicle unit integrated into the motor vehicle.

### DETAILED DESCRIPTION OF THE DRAWINGS

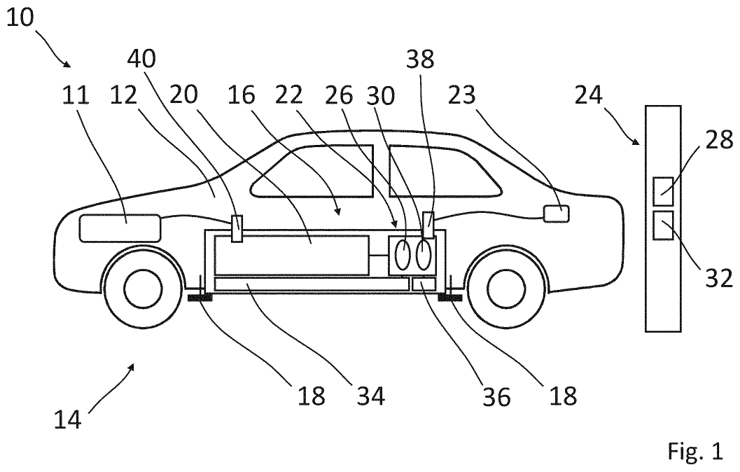

FIG. 1 Illustrates a motor vehicle 10 with an electric drive unit 11, a vehicle body 12 and an replaceable motor vehicle assembly 16 which has been provided on a vehicle underbody 14. In particular, a downwardly directed side of the motor vehicle assembly 16 at least partially creates the vehicle underbody 14.

The vehicle unit 16 is therefore exposed at the bottom so that it is (freely) accessible from the outside.

In addition, the vehicle assembly 16 is attached to the vehicle body 12 via a fastening device 18 in the area of the vehicle underbody 14.

The fastening device 18 is also freely and directly accessible from below i.e. in the area of the vehicle underbody 14.

FIG. 1 Illustrates the fastening device 18 in a locked status, in which the vehicle assembly unit 16 is coupled centrally to the vehicle body 12 via the fastening device 18. However, the fastening device 18 has been designed in such a way to be detachable and also enables the exchangeable vehicle assembly unit 16 to be uncoupled from the vehicle body 12.

The motor vehicle assembly 16 comprises an electrical storage unit 20 and a charging module 22 for charging the electrical storage unit 20. The electrical storage unit 20 and the charging module 22 are jointly attached and thereby form an inherently rigid, self-supporting structural unit 16, which can be replaced.

A charging socket 23 is provided in order to supply the electrical storage device 20 with electrical energy, which is electrically coupled to the charging module 22 and via which the charging module 22 can be electrically coupled to a power source 24. In this way, electrical energy can be routed from the power source 24 into the electrical storage device 20 i.e. the electrical storage device 20 can be charged.

Furthermore, the charging module 22 comprises a converter 26, by which the electrical storage device can be supplied with electrical energy via an alternating current source 28. In addition, or alternatively, the charging module 22 can comprise a voltage converter 30, via which the electrical storage device 20 can be supplied with electrical energy by a direct current source 32.

It can also be provided that the charging module 22 is equipped with an inverter via which electrical energy is fed from the electrical storage unit 20 into a power grid coupled via the charging module 22.

In addition, an inductive charging system 34 and/or a conductive charging system 36 can also be provided as part of the charging module 22.

An initial electrical vehicle-side interface 38 to the charging module 22 is provided in order to provide the charging module 22 with the electrical energy from the power source 24 via the charging socket 23, This can be automatically coupled to the charging module 22 during installation and for removal of the motor vehicle subassembly 16. FIG. 1 illustrates the first vehicle-side interface 34 in the coupled status with the charging module 22, so that the charging socket 23 is also electrically coupled to the charging module 22.

A second vehicle-side interface 40 is also provided in order to enable energy to be exchanged between the electric drive unit 11 and the electric storage unit 20 while the motor vehicle 10 is in motion. The electrical storage unit 20 can be automatically coupled via this interface when the vehicle unit 16 is installed or removed. FIG. 1 illustrates the coupled state, so that the electric drive unit 11 is electrically coupled to the electric storage unit 20.

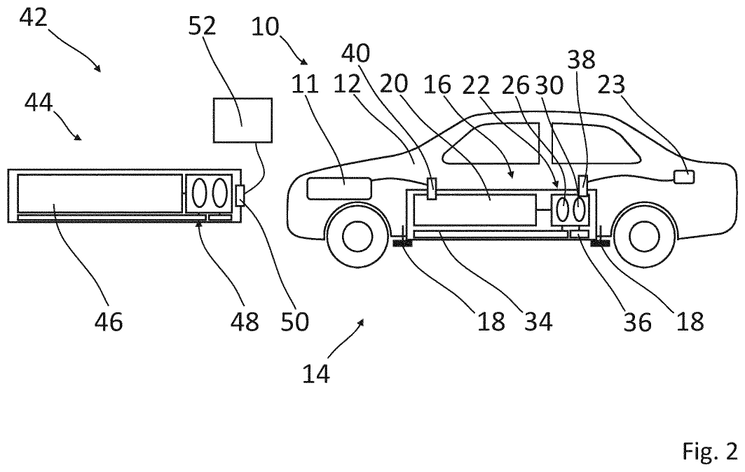

FIG. 2 illustrates an assembly 42, the assembly 42 comprising the motor vehicle 10 shown in FIG. 1 and a second motor vehicle subassembly 44 provided outside the motor vehicle 10.

The second motor vehicle structural unit 44 comprises an electrical storage unit 46 and a charging module 48, whereby the electrical storage unit 46 and the charging module 48 of the second motor vehicle structural unit 44 are attached to one another in the same way as those of the motor vehicle structural unit 16 and form an inherently rigid, self-supporting structural unit.

Furthermore, the charging module 48 of the second vehicle module 44 can also comprise a voltage converter, inverter and/or rectifier as well as inductive or conductive charging systems.

In contrast to the motor vehicle assembly 16, the second motor vehicle assembly 44 has an electrical storage unit 46 and/or a charging module 48, which differ from the electrical storage unit 16 or the charging module 22 in terms of different dimensions and/or technology.

Accordingly, the second motor vehicle assembly 44 forms an alternative assembly to the motor vehicle assembly 16, which has different characteristics due to a different electrical memory 46 and/or a different charging module 48. At the same time, however, it is designed in such a way that it is compatible with the motor vehicle 10 and can be provided instead of the motor vehicle module 16.

The second vehicle module 44 can have a more modern or larger electrical storage unit 46 than the first vehicle module 16, which allows a greater range of the motor vehicle 10. It is also conceivable that the charging module 48 is larger in order to enable shorter charging times or, for example, comprises a charging technology that is adapted to the local charging infrastructure.

Furthermore, the second motor vehicle assembly 44 may additionally comprise an interface 50 for exchanging thermal energy between the motor vehicle 10 and an infrastructure 52.

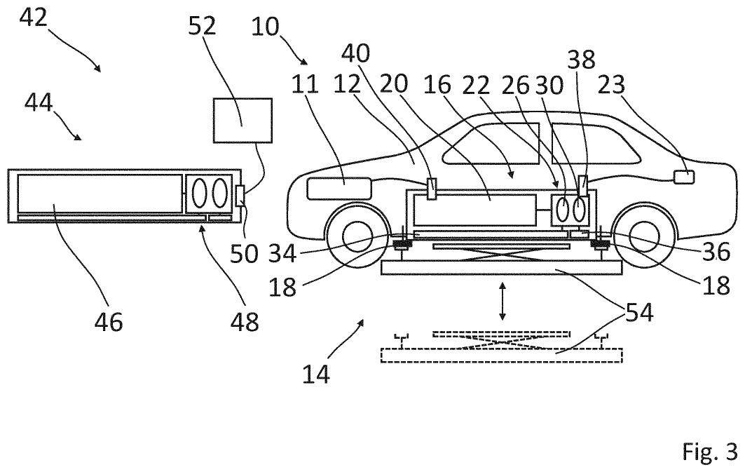

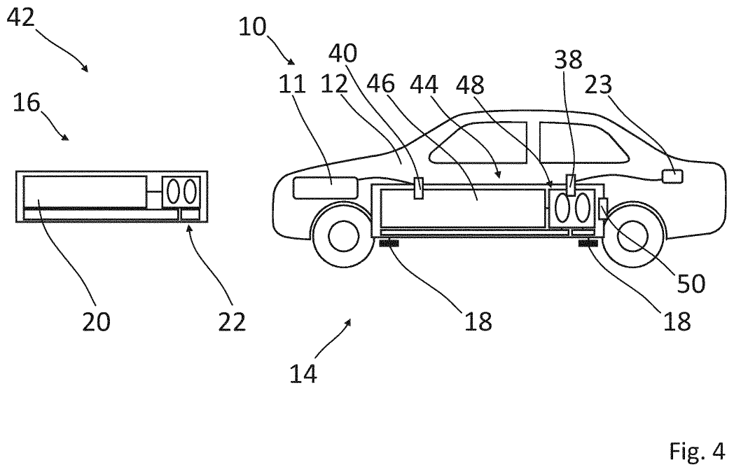

In the following, based on the above explanations of the assembly 42, the method for replacing the motor vehicle assembly 16 with the motor vehicle assembly 44 is explained with reference to FIGS. 3 and 4.

FIG. 3 illustrates the assembly 42 from FIG. 2 and an assembling device 54, which is arranged in the area of the vehicle underbody 14.

In the first step of the process, the assembling device 54 automatically releases the fastening device 18. This thereby mechanically decouples the vehicle assembly 16 from the vehicle body 12.

Furthermore, decoupling is also executed between the charging module 22 and the first vehicle-side interface 38 as well as the electrical storage unit 20 and the second vehicle-side interface 40, in particular automatically.

As a result, the charging module 22 is no longer electrically coupled to the charging socket 23, and the electric accumulator 20 is no longer electrically coupled to the electric drive unit 11.

When the motor vehicle assembly unit 16 has been removed by the assembly device 54, then the second motor vehicle assembly unit 44, which has been provided outside the motor vehicle 10, can be provided in a next step.

The motor vehicle assembly 44 is subsequently automatically picked up by the assembly device 54 and positioned in the area of the vehicle 10 where the motor vehicle assembly 16 was previously located.

Locking takes place via the mounting device 54, which mechanically couples the second motor vehicle assembly 44 to the vehicle body 12 in the area of the vehicle underbody 14 via the fastening device 18, in particular in an automated manner. Consequently, the motor vehicle assembly 44 is no longer provided outside the vehicle 10.

In order to electrically couple the charging module 48 of the second motor vehicle unit 44 to the charging socket 23, the first vehicle-side interface 38 is now coupled in. Furthermore, the second vehicle-side interface 40 is also coupled, so that the electric storage unit 46 is therefore electrically coupled to the electric drive unit 11.

FIG. 4 illustrates the assembly 42 after a fully completed process, in which the motor vehicle subassembly 16 is now provided outside the vehicle 10 and the second motor vehicle subassembly 44 is integrated into the vehicle 10.

Of course, other motor vehicle units can also be provided whereby the electrical storage and/or charging module differ from one another, so that a variation of motor vehicle units can be selected, all of which can be integrated into the motor vehicle 10.

1-11. (canceled)

12. A motor vehicle, comprising:
a motor vehicle structural unit integrated in the motor vehicle in such a way that the motor vehicle structural unit is exposed downward on an underbody of the motor vehicle, the motor vehicle structural unit being configured to be replaceable and comprising:
an electrical storage device; and
a charging module configured to charge the electrical storage device,
wherein the electrical storage device and the charging module are secured to each other to form a rigid, self-supporting, replaceable structural unit.

13. The motor vehicle according to claim 12, wherein the charging module comprises:
a rectifier configured to charge the electrical storage device via an alternating current source, and/or
a voltage converter configured to charge the electrical storage device via a direct current source.

14. The motor vehicle according to claim 12, wherein the charging module includes an inductive charging system and/or a conductive charging system.

15. The motor vehicle according to claim 12, further comprising:
a detachable fastening device that is freely and directly accessible from below, wherein the detachable fastening device is configured for central coupling and decoupling of the motor vehicle structural unit from a vehicle body of the motor vehicle.

16. The motor vehicle according to claim 12, further comprising:
a first vehicle-side interface to which the charging module is configured to be automatically coupled during installation and removal, wherein the first vehicle-side interface is configured to electrically couple a charging socket provided on the motor vehicle to the charging module.

17. The motor vehicle according to claim 16, further comprising:
a second vehicle-side interface to which the electrical storage device is configured to be automatically coupled during an installation and/or a removal of the motor vehicle structural unit, wherein the second vehicle-side interface is configured to directly or indirectly electrically couple or decouple an electrical drive unit provided in the motor vehicle to the electrical storage device.

18. The motor vehicle according to claim 12, wherein the motor vehicle structural unit at least partially comprises the underbody of the motor vehicle.

19. A motor vehicle structural unit, comprising:
an electrical storage device; and
a charging module, wherein:
the motor vehicle structural unit is provided outside of a motor vehicle,
the electrical storage device and the charging module of the motor vehicle structural unit are configured to be fastened to one another to form a rigid, self-supporting structural unit, and
the electrical storage device and/or the charging module of the motor vehicle structural unit differs from a second motor vehicle structural unit within the motor vehicle by a different dimensioning and/or technology.

20. The motor vehicle structural unit according to claim 19, further comprising:
an interface configured to replace thermal energy between the motor vehicle and an infrastructure.

21. A method for replacing a motor vehicle structural unit, comprising:
automatically detaching a detachable fastening device which is freely and directly accessible from below a motor vehicle;
decoupling a first motor vehicle structural unit from a vehicle body of the motor vehicle by an assembling device, the first motor vehicle structural unit comprising a first electrical storage device and a first charging module configured to charge the first electrical storage device;
decoupling the first charging module from a first vehicle-side interface and/or decoupling the first electrical storage device from a second vehicle-side interface;
providing a second motor vehicle structural unit outside the motor vehicle, the second motor vehicle structural unit having a second electrical storage device and a second charging module, wherein the second electrical storage device and/or the second charging module differ from the first electrical storage device and/or the first charging module in terms of a different dimensioning and/or technology;
automatically locking the detachable fastening device;
coupling the second motor vehicle structural unit to the vehicle body by the assembling device; and
coupling the second charging module into the first vehicle-side interface and/or coupling the second electric storage device into the second vehicle-side interface.

22. The method according to claim 21, wherein the first electrical storage device and the first charging module are configured to be secured to each other to form a rigid, self-supporting, replaceable structural unit.

23. The method according to claim 21, wherein the first charging module and/or the second charging module comprise:
a rectifier configured to charge the respective first electrical storage device or the second electrical storage device via an alternating current source, and/or
a voltage converter configured to charge the respective first electrical storage device or the second electrical storage device via a direct current source.

24. The method according to claim 21, wherein the first charging module and/or the second charging module include an inductive charging system and/or a conductive charging system.

25. The method according to claim 21, wherein the detachable fastening device is configured for central coupling and decoupling of the motor vehicle structural unit from the vehicle body of the motor vehicle.

26. The method according to claim 21, wherein the first vehicle-side interface is configured to electrically couple a charging socket provided on the motor vehicle to the first charging module or the second charging module.

27. The method according to claim 21, wherein the second vehicle-side interface is configured to directly or indirectly electrically couple or decouple an electrical drive unit provided in the motor vehicle to the first or the second electrical storage devices.

28. The method according to claim 21, wherein the motor vehicle structural unit at least partially comprises an underbody of the motor vehicle.

29. The method according to claim 21, wherein the second motor vehicle structural unit comprises an interface configured to replace thermal energy between the motor vehicle and an infrastructure.
